(19) United States
(12) Patent Application Publication
(10) Pub. No.: US 2011/0057462 A1
(43) Pub. Date: Mar. 10, 2011

(54) BUMPER AND BUMPER CONSTRUCTION KIT

(75) Inventors: Ralf Wuertemberger, Flein (DE); Gerhard Rinklin, Tiefenbronn (DE)

(73) Assignee: Dr. Ing. h.c.F. Porsche Aktiengesellschaft, Stuttgart (DE)

(21) Appl. No.: 12/877,598

(22) Filed: Sep. 8, 2010

(30) Foreign Application Priority Data
Sep. 8, 2009 (DE) 10 2009 040 602.6

(51) Int. Cl. B60R 19/04

(52) U.S. Cl. 293/151

(57) ABSTRACT

A bumper has a crossmember (2) on which at least one protection element (8) is fit. To reduce the development and/or production costs of motor vehicles in different countries, the bumper has at least one clearance (6,7) and at least one additional protection element (11,12) can be arranged in the clearance (6,7) if needed to meet the safety requirements of a particular country. The design and size of the additional protection element (11,12) are matched to the clearance (6,7).

### CROSS-REFERENCE TO RELATED APPLICATIONS

This application claims priority under 35 USC 119 to German Patent Application No. 10 2009 040 602.6 filed on Sep. 8, 2009, the entire disclosure of which is incorporated herein by reference.

### BACKGROUND OF THE INVENTION

1. Field of the Invention

The invention relates to bumper with a crossmember on which at least one protection element is fit.

2. Description of the Related Art

In the development of modern motor vehicles, road user protection increasingly is gaining in importance within passive safety. In particular, an accident between passenger vehicles and pedestrians and other unprotected traffic participants have serious consequences for the weaker party in the accident. Different countries may have different regulations regarding pedestrian protection to reduce the risk potential for pedestrians in collisions with motor vehicles.

It is the object of the invention to reduce the development and/or production costs of motor vehicles which are driven in different countries.

### SUMMARY OF THE INVENTION

The object is achieved by a bumper with a cross member on which at least one protection element is fit. More particularly, the bumper has at least one clearance in which at least one additional protection element can be arranged if the need arises. The design and size of the additional protection element are matched to the clearance. This affords the advantage that a bumper having different properties with regard to pedestrian protection can be produced in a simple manner by arranging various additional protection elements in the clearance. It is also possible not to arrange an additional protection element in the clearance. The bumper is covered to the outside in a known manner by at least one external cladding part that conceals the cross member, the protection element, the clearance and the additional protection element from the surroundings.

At least one additional protection element preferably is arranged in the clearance. The additional protection element in the clearance enables the properties of the bumper with regard to pedestrian protection to be varied in a simple manner.

At least one of a plurality of different additional protection elements that meet different country-specific requirements with regard to pedestrian protection preferably is arranged in the clearance. Thus, a bumper construction kit is provided to enable different pedestrian protection regulations in different countries to be met in a simple manner.

Each lateral end of the bumper preferably has a clearance in which at least one additional protection element can be arranged. The clearance also may be empty, depending on the pedestrian protection requirement. As a result, the pedestrian protection requirements for the lateral ends of the bumper can be varied in a particularly simple manner.

An insert for pedestrian protection may be arranged between the two clearances at the lateral ends of the bumper. The insert preferably is an energy-absorbing component made from plastic or aluminum.

At least one additional protection element may be arranged in each of the two clearances at the lateral ends of the bumper. The additional protection element may be a foam part that has a different hardness or a different deformation behavior than the insert for pedestrian protection. The additional protection element may also be designed as a plastics profile part with inner webs or ribs or as a sheet metal part. The additional protection element also may be designed as an extruded profile part. The additional protection element prevents pendulum-type penetration during a “pendulum impact” and keeps the external skin at a distance from the crossmember.

At least one additional protection element may be arranged between the crossmember and an external cladding part of the bumper. As a result, the deformation behavior of the bumper can be changed significantly in a simple manner. The additional protection element may be designed to be deformable to a greater or lesser extent.

At least one additional protection element may be arranged between the protection element and an external cladding part of the bumper. As a result, for example, the deformation behavior of the bumper can be varied in a simple manner in the region of the insert part.

At least one additional protection element may be arranged on the outside of the protection element. The additional protection element may be arranged laterally on the outside or on the outside at the front of the protection element.

The at least one additional protection element may be arranged between the protection element and a heat protection device for an external cladding part. The additional protection element serves, for example, to prevent undesirable deformation of the bumper, for example due to exhaust pipes, lights, spoilers or body-mounted components arranged in the vicinity.

The protection element and/or the additional protection element preferably have good energy absorption properties. Conventional materials for passive pedestrian protection systems can be used in the bumper of the invention.

The invention further relates to a bumper construction kit with a crossmember and a plurality of protection elements or additional protection elements that can be fit on the crossmember to produce different bumpers, as described previously. The bumper may be a front bumper or rear bumper of a motor vehicle and preferably is covered by at least one external cladding part. The crossmember can be fastened to the ends of longitudinal members of a motor vehicle preferably with the interconnection of crash boxes.

Other advantages, features and details of the invention emerge from the description below in which various exemplary embodiments are described in detail with reference to the drawings.

### BRIEF DESCRIPTION OF THE DRAWINGS

FIG. 1 is a perspective view of a bumper with a protection element according to a first embodiment.

FIG. 2 shows the bumper from FIG. 1 with two additional protection elements at the sides.

FIG. 3 is a perspective illustration of a rear bumper according to two further embodiments with different additional protection elements and a heat protection device.

### DETAILED DESCRIPTION OF THE PREFERRED EMBODIMENTS

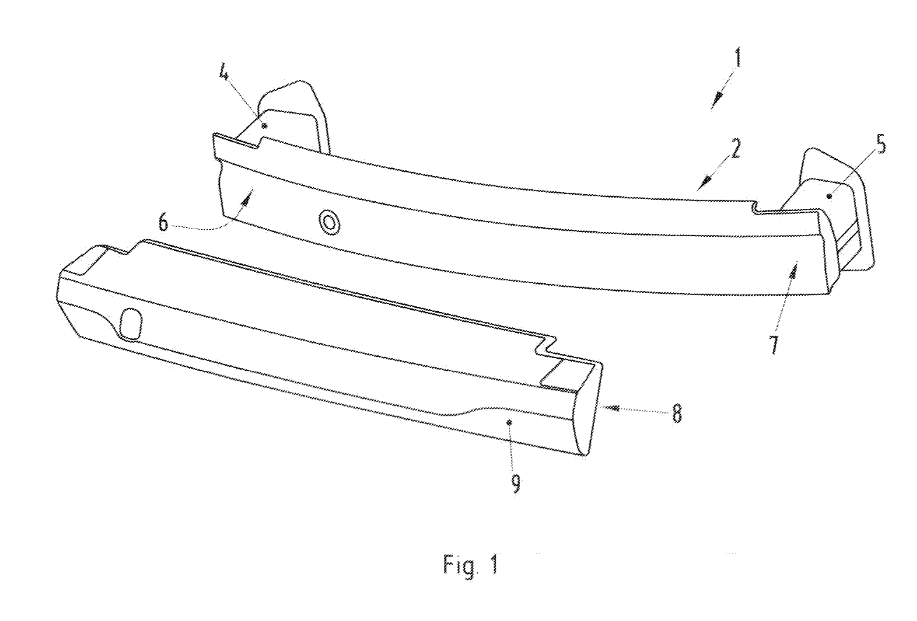

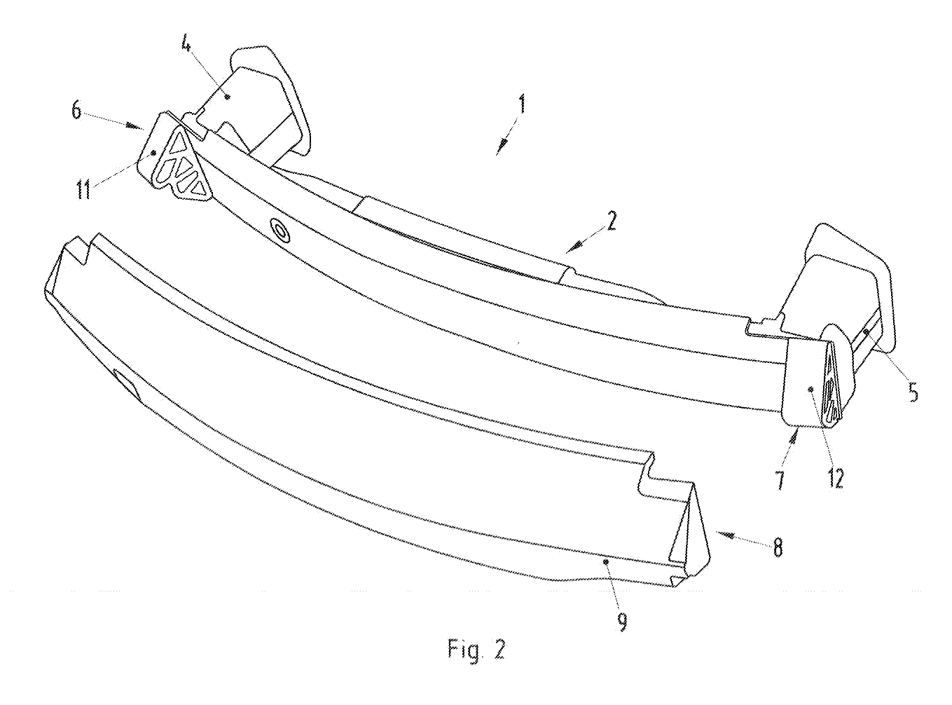

FIGS. 1 and 2 illustrate a front bumper 1 of a motor vehicle with a crossmember 2 that can be fastened to longitudinal members (not illustrated) of a supporting structure of a motor vehicle via the interconnection of crash boxes 4, 5. Two clearances 6, 7 are provided on the front side at the lateral ends of the crossmember 2 in the region of the crash boxes 4, 5.

A protection element 8 can be fastened to the crossmember 2 between the clearances 6, 7. The protection element 8 is, for example, an insert 9 made from foamed plastic and is somewhat shorter than the crossmember 2. The clearances 6, 7 are bounded laterally by the protection element 8 in the assembled state of the front bumper 1.

The clearances are bounded toward the outside by an external cladding (not illustrated) of the front bumper 1. The external cladding at least partially surrounds the protection element 8 and the crossmember 2. In the embodiment illustrated in FIG. 1, the clearances 6, 7 therefore constitute cavities that optionally are filled with air.

Additional protection elements 11, 12 are arranged in the clearances 6, 7 at the ends of the protection element 8 in the embodiment of FIG. 2. In contrast to the protection element 8, the additional protection elements 11, 12 are plastic profile parts with inner webs for ribs.

The cross sectional contour of the additional protection elements 11, 12 is matched to the cross sectional contour of the protection element 8 at the ends of the additional protection elements. However, the additional protection elements 11, 12 have a different deformation behavior than the protection element 8. In the assembled state, the protection element 8 and the additional protection elements 11, 12 are surrounded by the external cladding of the front bumper 1.

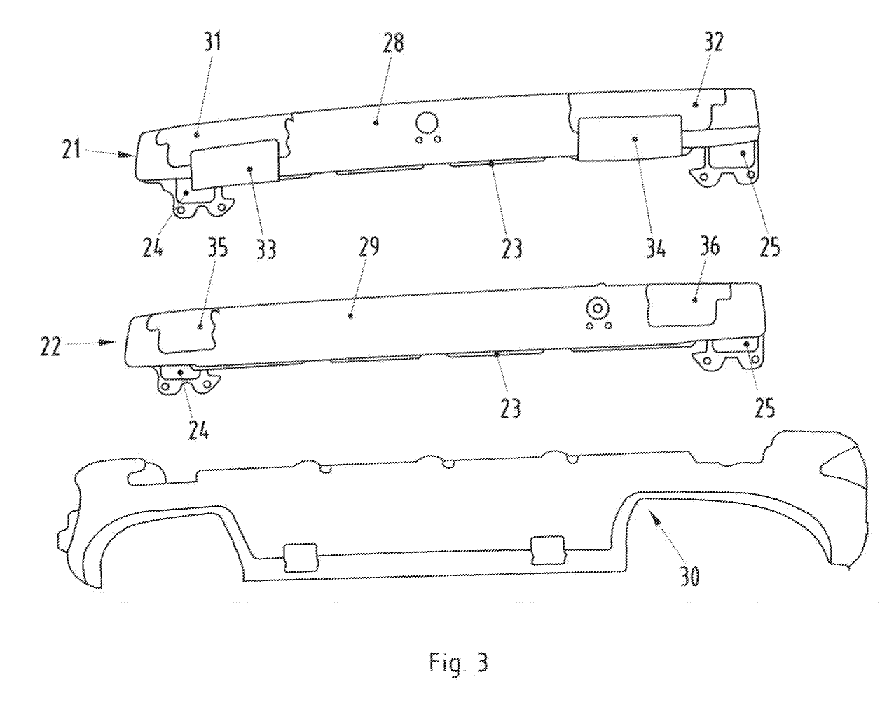

FIG. 3 illustrates different embodiments 21 and 22 of a rear bumper of a motor vehicle. The rear bumper 21; 22 has a crossmember 23 that can be fastened to longitudinal members (not illustrated) of the motor vehicle via interconnection of crash boxes 24, 25. A protection element 28, 29 is fastened to the crossmember 23. The two protection elements 28, 29 may be identical or different in design. In the assembled state, the rear bumper 21;22 is surrounded partially by a heat protection device 30.

In the different embodiments 21, 22 of the rear bumper, different additional protection elements 31, 32, 33, 34 and 35, 36 are fit on the protection element 28, 29. In the embodiment 21 of the rear bumper, two additional protection elements 31, 33 and 32, 34, in each case, are fit on the outside of the protection element 28 in a partially overlapping manner at the lateral regions. The additions protection elements 31, 32 have a meandering cross section. The additional protection elements 33 and 34 project down beyond the protection element 28.

In the embodiment 22 of the rear bumper, the two additional protection elements 35 and 36 are designed to be approximately shorter by half than the additional protection elements 31, 32 in the embodiment 21, but otherwise to be substantially identical. Further additional protection elements are not provided in the embodiment 22 of the rear bumper.

What is claimed is:

1. A bumper, comprising:
a crossmember;
at least one protection element fit on the crossmember;
at least one clearance with a selected size and configuration; and
at least one additional protection element having a size and configuration matched to the selected size and configuration of the clearance, the at least one additional protection element being arranged in the clearance if needed.

2. The bumper of claim 1, wherein the at least one additional protection element is arranged in the clearance.

3. The bumper of claim 1, wherein at least one of a plurality of different additional protection elements which meet different country-specific requirements with regard to pedestrian protection is arranged in the clearance.

4. The bumper of claim 1, wherein the at least one clearance comprises lateral end clearances disposed at opposite lateral ends of the bumper, each of the lateral end clearance having at least one of the additional protection elements arranged therein.

5. The bumper of claim 4, further comprising an insert for pedestrian protection arranged between the clearances at the lateral ends of the bumper.

6. The bumper of claim 5, wherein at least one of the additional protection elements is arranged in each of the two clearances at the lateral ends of the bumper.

7. The bumper of claim 4, further comprising external cladding disposed so that the at least one additional protection element is arranged between the crossmember and the external cladding.

8. The bumper of claim 1, further comprising external cladding disposed so that the at least one additional protection element is arranged between the crossmember and the external cladding.

9. The bumper of claim 1, wherein the at least one additional protection element is arranged on exteriorly of the protection element.

10. The bumper of claim 9, wherein the at least one additional protection element is arranged between the protection element and a heat protection device or an external cladding part.

11. The bumper of claim 1, wherein the protection element and the additional protection element have good energy absorption properties.

12. A bumper construction kit, comprising
a crossmember;
protection elements configured to fit on the crossmember;
the crossmember and the protection elements being configured to define clearances with a selected size and configuration; and
a plurality of additional protection element having a size and configuration matched to the selected size and configuration of the clearances so that at least one of the additional protection elements can be arranged in the clearance if needed.

13. The bumper construction kit of claim 12, wherein the at least one clearance comprises lateral end clearances disposed at opposite lateral ends of the bumper, each of the lateral end clearance having at least one of the additional protection elements arranged therein.

14. The bumper construction kit of claim 13, further comprising external cladding disposed so that the at least one additional protection element (11,12;31-36) is arranged between the crossmember (2;23) and the external cladding.
